(19) United States
(12) Patent Application Publication
(10) Pub. No.: US 2026/0346801 A1
(43) Pub. Date: Nov. 5, 2026

(54) IN-VEHICLE DEVICE AND IN-VEHICLE SYSTEM

(71) Applicant: DENSO CORPORATION, Kariya-city (JP)

(72) Inventors: Tetsuo NAKAGAWA, Kariya-shi (JP); Tomohisa KISHIGAMI, Kariya-shi (JP)

(21) Appl. No.: 19/447,781

(22) Filed: Jan. 13, 2026

(30) Foreign Application Priority Data
Jan. 17, 2025 (JP) 2025-006958

(51) Int. Cl. B60R 16/03; B60R 16/023; B60W 50/02

(52) U.S. Cl. CPC B60R 16/03; B60R 16/023; B60W 50/0205

(57) ABSTRACT

An in-vehicle device used in an in-vehicle system in which a plurality of communication devices are installed is provided. Each of the plurality of communication devices is configured to receive power supply, and each of the power supply paths is provided with a power supply switching unit configured to switch between an ON state and an OFF state. The in-vehicle device is configured to execute switching control to switch the power supply switching unit to either the ON state or the OFF state, and communicate with the plurality of communication devices. The in-vehicle device outputs control information indicating whether the switching control is a switching to the ON state or a switching to the OFF state. The plurality of communication devices stops the transmission process for transmitting communication frames.

### CROSS REFERENCE TO RELATED APPLICATION

This application is based on Japanese Patent Application No. 2025-006958 filed on Jan. 17, 2025, the disclosure of which is incorporated herein by reference.

### TECHNICAL FIELD

The present disclosure relates to an in-vehicle device and an in-vehicle system.

### BACKGROUND

A related art describes an in-vehicle system comprising a power supply device and a plurality of communication devices. The power supply device and each communication device are connected by power supply lines that extend from the power supply device and branch according to the number of communication devices. Each branched power supply line is provided with a power supply interruption unit corresponding to each communication device. The power supply interruption unit interrupts the power supply from the power supply device to the communication device. According to the in-vehicle system, power supply can be interrupted for each communication device, so it is possible to selectively interrupt power supply only to communication devices for which communication is unnecessary.

### SUMMARY

According to an aspect of the present disclosure, an in-vehicle device used in an in-vehicle system in which a plurality of communication devices are installed is provided. Each of the plurality of communication devices is configured to receive power supply via each power supply path. Each of the power supply paths is provided with a power supply switching unit configured to switch between an ON state in which the respective power supply path is conducted and an OFF state in which the respective power supply path is interrupted. The in-vehicle device includes at least one of (i) a circuit and (ii) a processor with a memory storing computer program code executable by the processor, the at least one of the circuit and the processor configured to cause the in-vehicle device to execute switching control to switch the power supply switching unit to either the ON state or the OFF state; and communicate with the plurality of communication devices. The at least one of the circuit and the processor may output control information indicating whether the switching control executed is a switching to the ON state or a switching to the OFF state, when the switching control is executed. Each of the plurality of communication devices is configured to, when the control information output corresponding to a respective communication device is acquired, stop transmission process for transmitting a communication frame when the control information indicates a switch to the OFF state for the respective communication device.

### BRIEF DESCRIPTION OF DRAWINGS

Objects, features and advantages of the present disclosure will become more apparent from the following detailed description made with reference to the accompanying drawings. In the drawings:

FIG. 1 is a block diagram showing the configuration of the communication system according to the embodiment;

FIG. 2 is a block diagram of the electronic control unit;

FIG. 3A is a diagram for explaining examples of management information;

FIG. 3B is a diagram for explaining examples of switching control;

FIG. 3C is a diagram for explaining examples of control information;

FIG. 4 is a sequence diagram showing the switching process under normal conditions;

FIG. 5 is a sequence diagram showing the switching process to the OFF state during a stuck-ON fault;

FIG. 6 is a sequence diagram showing the switching process to the ON state during a stuck-ON fault;

FIG. 7 is a flowchart showing the process when executing switching control;

FIG. 8 is a flowchart showing the process when stopping the transmission process;

FIG. 9 is a flowchart showing the process when starting the transmission process;

FIG. 10 is a block diagram showing the configuration of the communication system in modified example 1;

FIG. 11 is a block diagram showing the configuration of the communication system in modified example 2; and

FIG. 12 is a block diagram showing the configuration of the communication system in modified example 3.

### DETAILED DESCRIPTION

As a result of detailed investigation by the inventors, the following problems have been identified. That is, if the power supply interruption unit fails, it may not be possible to interrupt the power supply. Even if a communication device is in a situation where communication is originally unnecessary, if the power supply is not interrupted, the communication device may perform unnecessary communication.

The present disclosure provides a technology that prevents communication devices from performing unnecessary communication even when power supply to the communication devices is not interrupted.

According to one aspect of the present disclosure, an in-vehicle device used in an in-vehicle system in which a plurality of communication devices are installed is provided. Each of the plurality of communication devices is configured to receive power supply via each power supply path. Each of the power supply paths is provided with a power supply switching unit configured to switch between an ON state in which the respective power supply path is conducted and an OFF state in which the respective power supply path is interrupted. The in-vehicle device includes: a control unit configured to execute switching control to switch the power supply switching unit to either the ON state or the OFF state; and a communication unit configured to communicate with the plurality of communication devices. The communication unit outputs control information indicating whether the switching control executed by the control unit is a switching to the ON state or a switching to the OFF state, when the control unit executes the switching control. Each of the plurality of communication devices is configured to, when the control information output by the communication unit corresponding to a respective communication device is acquired, stop transmission process for transmitting a communication frame when the control information indicates a switch to the OFF state for the respective communication device.

With such a configuration, even if the power supply path is actually not interrupted, the plurality of communication devices can recognize that it is a situation in which the power supply switching unit corresponding to each communication device should originally be switched to the OFF state. Therefore, the plurality of communication devices can stop transmission processing as if the power supply switching unit had actually switched to the OFF state. Accordingly, even if power supply to the plurality of communication devices is not interrupted, the plurality of communication devices will not perform unnecessary communication.

One aspect of the present disclosure may also be an in-vehicle system in which a plurality of communication devices and an in-vehicle device are installed.

Exemplary embodiments of the present disclosure will be described with reference to the drawings.

### 1. Embodiment

### 1-1. Configuration

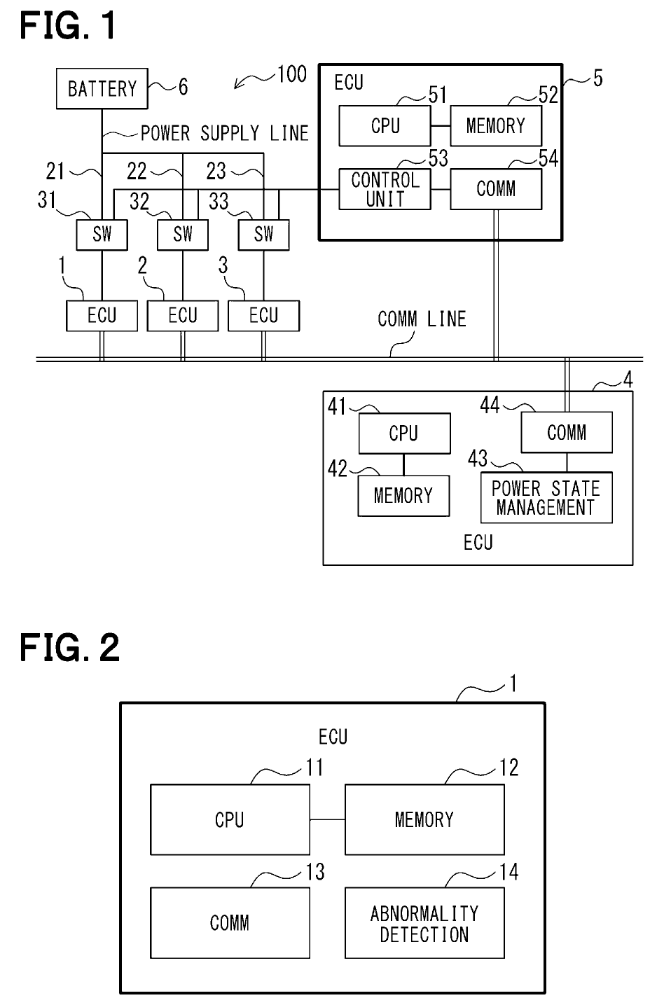

The communication system 100 shown in FIG. 1 is, for example, a network system installed in a vehicle such as a passenger car. The communication system 100 is an in-vehicle system equipped with a plurality of electronic control units (hereinafter referred to as ECUs 1-5). The plurality of ECUs 1-5 are connected to each other via communication lines so as to be capable of data communication. ECU stands for "Electronic Control Unit."

ECUs 1-5 receive power supply from a battery 6 installed in the vehicle via power supply lines. The battery 6 supplies power at a DC battery voltage (for example, 12V). The power supply lines branch out from the battery 6 and are extended to form power supply paths 21-23. In this embodiment, ECU 1 receives power supply from the battery 6 via the power supply path 21 between the battery 6 and ECU 1. ECU 2 receives power supply from the battery 6 via the power supply path 22 between the battery 6 and ECU 2. ECU 3 receives power supply from the battery 6 via the power supply path 23 between the battery 6 and ECU 3. Although the power supply paths for ECUs 4 and 5 are omitted in the illustration, ECUs 4 and 5 also receive power supply from the battery 6.

ECUs 1-5 are configured to be capable of transitioning between a wake-up state, which is a normal operating state, and a sleep state, which is a low power consumption operating state in which at least part of their functions are restricted. For example, in the wake-up state, ECUs 1-5 can use all the functions they possess. On the other hand, in the sleep state, functions other than the reception process described later may be restricted for ECUs 1-5. ECUs 1-5 transition from the wake-up state to the sleep state when none of the ECUs receives a communication request. In other words, if none of the ECUs receives a communication request for a predetermined period of time, ECUs 1-5 transition to the sleep state. Conversely, if any ECU receives a communication request, ECUs 1-5 maintain the wake-up state.

For example, when power supply from the battery 6 to each ECU 1-5 is stopped, each ECU 1-5 stops transmitting communication requests and transitions to the sleep state. That is, when all ECUs 1-5 constituting the communication system 100 stop transmitting communication requests, none of the ECUs 1-5 receives communication requests, so the entire communication system 100 transitions to a low power consumption state. A communication request indicates a request to transmit a communication frame.

Power supply paths 21-23 are each provided with a power supply switching unit 31-33. The power supply switching units 31-33 are configured to switch between an ON state in which each power supply path 21-23 is conducted and an OFF state in which each power supply path 21-23 is interrupted. The power supply switching units 31-33 may be implemented, for example, as mechanical relays having mechanical contacts or semiconductor relays without mechanical contacts. In this embodiment, the power supply switching units 31-33 are implemented using semiconductor relays such as FETs. The control unit 53, described later, applies a gate voltage to the gate terminal of the FET, thereby switching the FET to the ON state. Note that the power supply switching units 31-33 may also be illustrated as SW31-33.

As shown in FIG. 2, ECU 1 comprises a CPU 11 and a memory 12. The memory 12 stores a program for the CPU 11 to execute predetermined functions. ECU 1 realizes the functions of the following units by the CPU 11 executing the program stored in the memory 12. Specifically, ECU 1 has the functions of a communication unit 13 and an anomaly detection unit 14, which may be referred to as an abnormality detection unit.

The communication unit 13 is configured to be capable of communicating with ECUs 2-5. More specifically, the communication unit 13 executes a transmission process for transmitting communication frames and a reception process for receiving communication frames. When the communication unit 13 receives control information output by the communication unit 54 of ECU 5, if the control information for itself indicates switching to the OFF state, it is configured to stop the transmission process. On the other hand, when the communication unit 13 acquires control information output by the communication unit 54 of ECU 5, if the control information for itself indicates switching to the ON state, it is configured to start the transmission process.

The anomaly detection unit 14 is configured to perform communication anomaly detection (hereinafter also referred to as anomaly detection processing) for detecting whether there is an abnormality in the communication state of the communication system 100. For example, as communication anomaly detection, the anomaly detection unit 14 executes disconnection determination to determine whether communication frames that should be received from other ECUs have been interrupted. More specifically, if the state in which communication frames transmitted from other ECUs are not received continues for a preset communication anomaly determination time (for example, 2 seconds), the anomaly detection unit 14 determines that a communication anomaly has occurred with another ECU and that there is an abnormality in the communication state of the communication system.

When the anomaly detection unit 14 receives control information output by the communication unit 54 of ECU 5, if the control information for itself indicates switching to the OFF state, it stops communication anomaly detection. On the other hand, when the anomaly detection unit 14 receives control information output by the communication unit 54 of ECU 5, if the control information for itself indicates switching to the ON state, it starts communication anomaly detection.

Block diagrams of ECUs 2 and 3 are omitted, but ECUs 2 and 3 have the same configuration as ECU 1. Returning to FIG. 1, ECU 4 includes a CPU 41 and a memory 42. The memory 42 stores a program for the CPU 41 to execute predetermined functions.

ECU 4 realizes the functions of the following units by the CPU 41 executing the program stored in the memory 42. Specifically, ECU 4 functions as a power state management unit 43 and a communication unit 44.

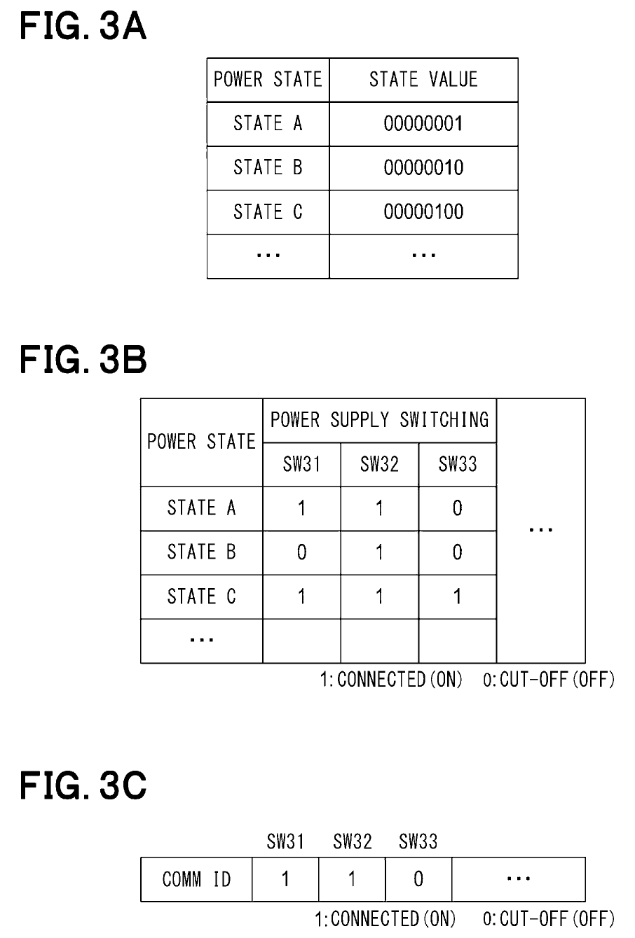

The power state management unit 43 is configured to manage whether each power supply switching unit 31-33 should transition to the ON state or the OFF state according to the running state of the vehicle. As one example, as shown in FIG. 3A, the power state management unit 43 classifies power states in advance and manages them as management information. Management information is information indicating whether the power supply switching units 31-33 should transition to the ON state or the OFF state. For example, State A is a rule established in advance indicating that power is supplied to ECU 1 and ECU 2, but not to ECU 3. In other words, State A indicates that the power supply switching units 31 and 32 should transition to the ON state, but the power supply switching unit 33 should transition to the OFF state.

Further, for example, State B is a predefined rule indicating that power is supplied to ECU 2, but not to ECU 1 or ECU 3. In other words, State B indicates that the power supply switching unit 32 should transition to the ON state, but the power supply switching units 31 and 33 should transition to the OFF state. Further, for example, State C is a rule established in advance indicating that power is supplied to ECUs 1-3. In other words, State C indicates that the power supply switching units 31-33 should transition to the ON state.

For example, the power state management unit 43 manages the relationship between the running state of the vehicle and the states. When the running state changes from cruise control execution to cruise control cancellation, the state should be changed from State B to State C.

The communication unit 44 is configured to be capable of communicating with ECUs 1-3 and 5. The power state management unit 43 notifies the management information to the control unit 53 of ECU 5, described later, via the communication unit 44. ECU 5 includes a CPU 51 and a memory 52. The memory 52 stores a program for the CPU 51 to execute predetermined functions.

ECU 5 realizes the functions of the following units by the CPU 51 executing the program stored in the memory 52. Specifically, ECU 5 has functions as a control unit 53 and a communication unit 54.

The control unit 53 is configured to execute switching control to switch the power supply switching units 31-33 to either the ON state or the OFF state. The control unit 53 executes switching control in accordance with the management information notified from the power state management unit 43. As shown in FIG. 3B, an example is described in which State A is notified as management information. In the case of State A, a rule is set in advance such that the power supply switching units 31 and 32 are switched to the ON state, and the power supply switching unit 33 is switched to the OFF state. The control unit 53 applies gate voltage to the gate terminals of the power supply switching units 31 and 32. On the other hand, the control unit 53 stops applying gate voltage to the gate terminal of the power supply switching unit 33.

Similarly, when State B is notified, a rule is set in advance such that the power supply switching unit 32 is switched to the ON state, and the power supply switching units 31 and 33 are switched to the OFF state. When State C is notified, a rule is set in advance such that the power supply switching units 31, 32, and 33 are switched to the ON state. The control unit 53 executes switching control according to the type of state notified from the power state management unit 43.

Further, the control unit 53 instructs the communication unit 54 to output control information. Control information is information indicating whether the switching control executed by the control unit 53 is a switching to the ON state or a switching to the OFF state. For example, as shown in FIG. 3C, the communication frame for notifying control information associates the most significant bit (MSB) of the data field with the power supply switching unit 31, the second bit with the power supply switching unit 32, and the third bit with the power supply switching unit 33. If the value of the bit is "1," it indicates that the control unit 53 has executed switching control to switch the power supply switching unit to the ON state; if the value of the bit is "0," it indicates that the control unit 53 has executed switching control to switch the power supply switching unit to the OFF state.

Here, even if the control unit 53 stops applying gate voltage to the gate terminal, an abnormality (hereinafter also referred to as stuck-ON fault) may occur in which the power supply switching unit does not switch to the OFF state and remains in the ON state.

However, regardless of how the power supply switching units 31-33 are actually switched, the control unit 53 instructs the communication unit 54 to output control information regarding the switching control executed by the control unit 53. That is, even if the control unit 53 executes switching control to switch the power supply switching unit to the OFF state, but in reality a stuck-ON fault occurs in the power supply switching unit and it does not switch to the OFF state, the control unit 53 instructs the communication unit 54 to output control information indicating that switching control to the OFF state has been executed.

Furthermore, even if the control unit 53 executes switching control to switch the power supply switching unit to the ON state, but in reality a stuck-ON fault has occurred and the power supply switching unit has remained in the ON state continuously since before the switching control was executed, the control unit 53 instructs the communication unit 54 to output control information indicating that switching control to the ON state has been executed. The communication unit 54 is configured to be capable of communicating with ECUs 1-4. When switching control is executed by the control unit 53, the communication unit 54 outputs the control information received from the control unit 53.

### 1-2. Process

### 1-2-1. Process Under Normal Condition

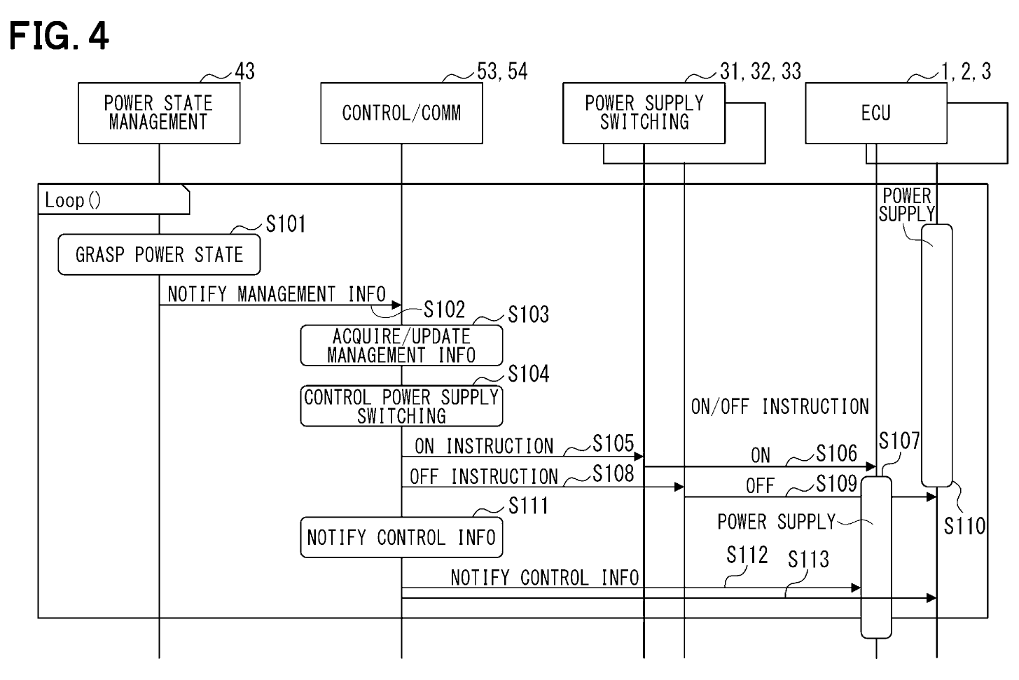

The processing (hereinafter referred to as switching processing) executed in the communication system 100 will be explained using the sequence diagram of FIG. 4. First, an overview of the switching processing under normal conditions will be described. That is, the overview of the switching processing when none of the power supply switching units 31-33 has a stuck-ON fault will be explained. This switching processing is repeatedly executed at a predetermined cycle during the operation of the power state management unit 43. Note that this switching processing may also be executed each time the running state of the vehicle changes and a situation arises in which the power state should be changed.

First, in S101, the power state management unit 43 acquires the power state. More specifically, the power state management unit 43 determines, according to the running state of the vehicle, to which state the system should transition.

Next, in S102, the power state management unit 43 notifies the control unit 53 of the management information. More specifically, the power state management unit 43 notifies the control unit 53 of the state determined in S101. Subsequently, in S103, the control unit 53 acquires the management information. In addition, since the control unit 53 retains the management information previously notified from the power state management unit 43, when new management information is notified, the retained management information is updated.

In S104, the control unit 53 executes switching control in accordance with the management information. More specifically, switching control for each power supply switching unit 31-33 is executed according to the value of the state. If, in S105, switching to the ON state is executed, the power supply path is conducted as in S106. Then, in S107, the ECUs 1-3 corresponding to the power supply switching units 31-33 for which switching to the ON state has been executed are supplied with power. ECUs 1-3, upon the start of power supply, transition from the sleep state to the wake-up state and start the transmission process.

On the other hand, if, in S108, switching to the OFF state is executed, the power supply path is interrupted as in S109. Then, in S110, the ECUs 1-3 corresponding to the power supply switching units 31-33 for which switching to the OFF state has been executed have their power supply stopped. ECUs 1-3, upon the stop of power supply, transition from the wake-up state to the sleep state and stop the transmission process.

In S111, the communication unit 54 transmits the control information. In S112, it is notified to the ECUs 1-3 corresponding to the power supply switching units 31-33 for which switching to the ON state has been executed that the switching control executed by the control unit 53 is a switching to the ON state. On the other hand, in S113, it is notified to the ECUs 1-3 corresponding to the power supply switching units 31-33 for which switching to the OFF state has been executed that the switching control executed by the control unit 53 is a switching to the OFF state. ECU 5 notifies the control information regardless of whether a stuck-ON fault has occurred in the power supply switching units 31-33. Also, under normal conditions, even if control information is transmitted, ECUs 1-3 do not perform any special processing.

### 1-2-2. Switching Process to OFF State During Stuck-ON Fault

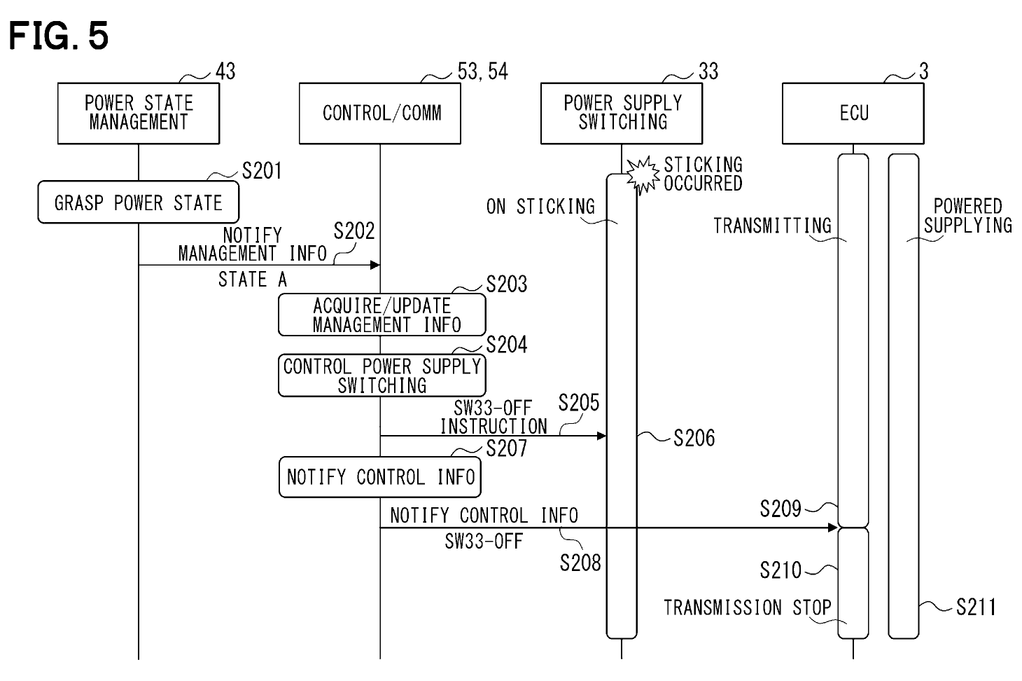

An overview of the switching process to the OFF state during a stuck-ON fault will be explained using the sequence diagram in FIG. 5. In this sequence diagram, it is assumed that a stuck-ON fault has occurred in the power supply switching unit 33.

In S201, the power state management unit 43 acquires the power state. For example, the power state management unit 43 determines that the system should transition to State A. In S202, the power state management unit 43 notifies the control unit 53 of the management information. For example, the power state management unit 43 notifies the control unit 53 of State A determined in S201.

Subsequently, in S203, the control unit 53 acquires the management information. The control unit 53 also updates the currently retained management information to the new management information. Then, in S204, the control unit 53 executes switching control in accordance with the management information. Specifically, the control unit 53 executes switching control for each power supply switching unit 31-33 according to the value of State A.

As in S205, the control unit 53 executes switching to the OFF state for the power supply switching unit 33. However, as in S206, the power supply switching unit 33 is in a stuck-ON fault state, which is also referred to as an ON sticking state. Therefore, the power supply path 23 is not interrupted, and as in S211, ECU 3 remains powered. Normally, power supply to ECU 3 should be stopped, and the transmission process should also be stopped accordingly, but since ECU 3 remains powered, as in S209, ECU 3 continues the transmission process.

In S207, the communication unit 54 transmits the control information. Specifically, as in S208, it is notified to ECU 3 that the switching control executed by the control unit 53 for the power supply switching unit 33 is a switching to the OFF state.

ECU 3, upon receiving the control information indicating that the switching control executed for the power supply switching unit 33 is a switching to the OFF state, stops the transmission process as in S210. That is, ECU 3 stops the transmission process even while it remains powered. As a result, the transmission process, which would normally be stopped when the power supply to ECU 3 is cut off, is properly stopped. ECU 3 does not stop the reception process. As will be described in detail later, there may be cases where ECU 3 receives a notification indicating that the control unit 53 has executed switching control to switch the power supply switching unit 33 to the ON state, and then resumes the transmission process.

### 1-2-3. Switching Process to ON State During Stuck-ON Fault

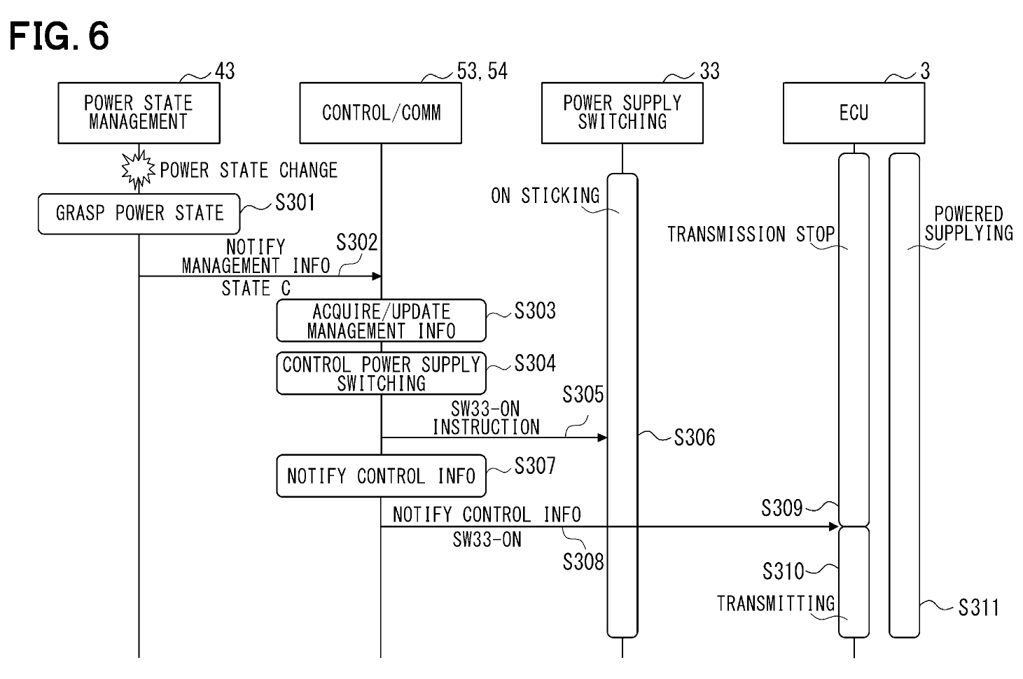

An overview of the switching process to the ON state during a stuck-ON fault will be explained using the sequence diagram in FIG. 6. In this sequence diagram, it is assumed that a stuck-ON fault has occurred in the power supply switching unit 33. Furthermore, it is based on the state after execution of S208 and S210 in the sequence diagram of FIG. 5. That is, it is assumed that a stuck-ON fault has occurred in the power supply switching unit 33, the power supply path 23 is not interrupted, ECU 3 remains powered, but the transmission process is stopped.

When the running state of the vehicle changes and a situation arises in which the power state should be changed, in S301, the power state management unit 43 acquires the new power state. For example, the power state management unit 43 determines that the system should transition to State C.

In S302, the power state management unit 43 notifies the management information to the control unit 53. For example, the power state management unit 43 notifies the control unit 53 of State C determined in S301. Subsequently, in S303, the control unit 53 acquires the management information. The control unit 53 also updates the currently retained management information to the new management information.

Then, in S304, the control unit 53 executes switching control in accordance with the management information. Specifically, the control unit 53 executes switching control for each power supply switching unit 31-33 according to the value of State C.

In S305, the control unit 53 executes switching to the ON state for the power supply switching unit 33. Here, in S306, the power supply switching unit 33 remains in the stuck-ON fault state. Therefore, the power supply path 23 is not interrupted, and in S311, ECU 3 remains powered. Normally, the transition of power supply to ECU 3 from stop to start should also trigger a change in the transmission process from stop to start, but as described in the premise, ECU 3 is powered and the transmission process is stopped (S309).

In S307, the communication unit 54 notifies the control information. Specifically, as in S308, it is notified to ECU 3 that the switching control executed by the control unit 53 for the power supply switching unit 33 is a switching to the ON state.

ECU 3, upon receiving the control information indicating that the switching control executed for the power supply switching unit 33 is a switching to the ON state, resumes the transmission process as in S310. As a result, the transmission process, which would normally be started when the power supply to ECU 3 is initiated, is properly started.

### 1-2-4. Process When Executing Switching Control

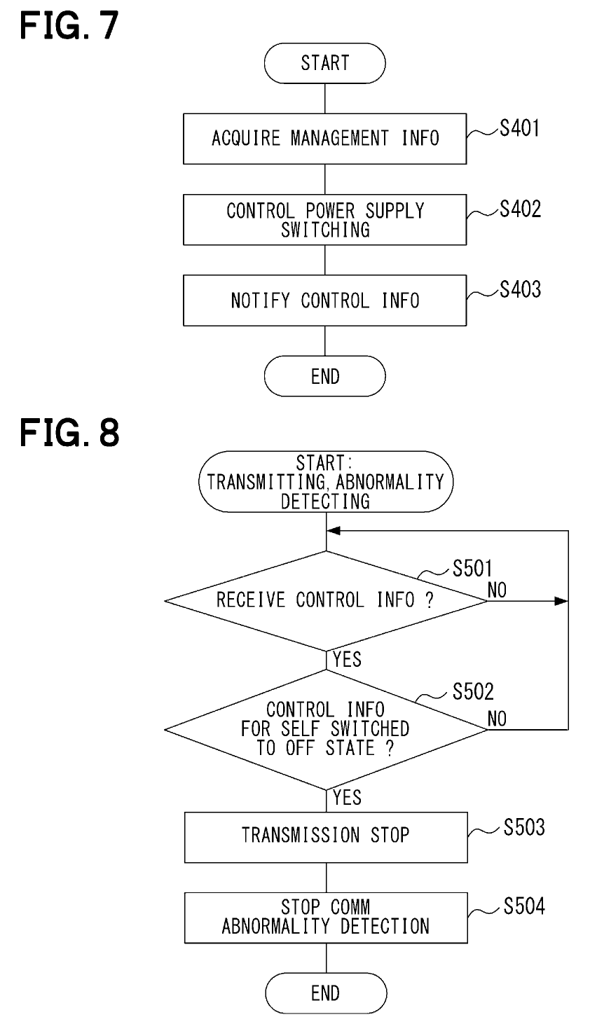

The processing performed when ECU 5 executes switching control will be explained using the flowchart in FIG. 7. This processing is executed each time management information is notified from the power state management unit 43.

In S401, the control unit 53 acquires the management information from the power state management unit 43 via the communication unit 54. In S402, the control unit 53 executes switching control for each power supply switching unit 31-33 in accordance with the management information. Subsequently, in S403, the communication unit 54 notifies the control information. Thereafter, ECU 5 ends this processing.

### 1-2-5. Processing When Stopping Transmission Process

The processing performed when ECUs 1-3 receive control information and stop the transmission process will be explained using the flowchart in FIG. 8. This processing is repeatedly executed while the transmission process and anomaly detection process are ongoing.

In S501, ECUs 1-3 determine whether control information has been received. For example, ECUs 1-3 determine that control information has been received when a communication frame with a preset communication ID is received.

If ECUs 1-3 determine in S501 that control information has not been received, the process returns to the start. On the other hand, if ECUs 1-3 determine in S501 that control information has been received, the process proceeds to S502.

In S502, ECUs 1-3 determine whether the control information for themselves indicates switching to the OFF state. Specifically, ECUs 1-3 check whether the bit in the data field of the communication frame notifying the control information, corresponding to their own ECU, is "1" (i.e., switching to the ON state) or "0" (i.e., switching to the OFF state).

If ECUs 1-3 determine in S502 that the control information for themselves does not indicate switching to the OFF state (in other words, if it indicates switching to the ON state), the process returns to the start. In the case of switching to the ON state, the transmission process and anomaly detection process should continue as is.

On the other hand, if ECUs 1-3 determine in S502 that the control information for themselves indicates switching to the OFF state, the process proceeds to S503. In S503, ECUs 1-3 stop the transmission process.

Subsequently, in S504, ECUs 1-3 also stop the anomaly detection process. Like the transmission process, the anomaly detection process is, in principle, not executed when power supply is interrupted (in other words, in the sleep state). Furthermore, if the anomaly detection process is executed at a timing when it should not be, it may lead to false determination. Therefore, from the perspective of not executing unnecessary processing, the anomaly detection process is also stopped.

### 1-2-6. Process When Starting Transmission Process

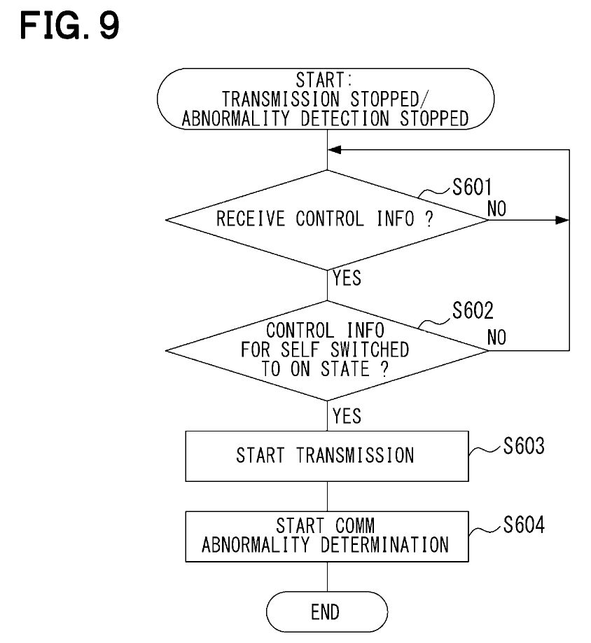

The processing performed when ECUs 1-3 receive control information and start the transmission process will be explained using the flowchart in FIG. 9. This processing is repeatedly executed while the transmission process and anomaly detection process are stopped.

In S601, ECUs 1-3 determine whether control information has been received. If ECUs 1-3 determine in S601 that control information has not been received, the process returns to the start. On the other hand, if ECUs 1-3 determine in S601 that control information has been received, the process proceeds to S602.

In S602, ECUs 1-3 determine whether the control information for themselves indicates switching to the ON state. If ECUs 1-3 determine in S602 that the control information for themselves does not indicate switching to the ON state (in other words, if it indicates switching to the OFF state), the process returns to the start. In the case of switching to the OFF state, the transmission process and anomaly detection process should remain stopped.

On the other hand, if ECUs 1-3 determine in S602 that the control information for themselves indicates switching to the ON state, the process proceeds to S603. In S603, ECUs 1-3 start the transmission process. Subsequently, in S604, ECUs 1-3 also start the anomaly detection process. This is because, in principle, it is the timing when the anomaly detection process should be executed, just like the transmission process.

### 1-3. Effects

According to the embodiment described in detail above, the following effects can be obtained.

(1a) When switching control is executed by the control unit 53, the communication unit 54 outputs control information indicating whether the switching control executed by the control unit 53 is a switching to the ON state or a switching to the OFF state. When ECUs 1-3 acquire the control information output by the communication unit 54, if the control information for themselves indicates switching to the OFF state, they are configured to stop the transmission process for transmitting communication frames. With such a configuration, even if the power supply path is not actually interrupted, ECUs 1-3 can recognize that the corresponding power supply switching units 31-33 should be switched to the OFF state. Therefore, ECUs 1-3 can stop the transmission process in the same manner as when the power supply switching units 31-33 are actually switched to the OFF state. Accordingly, even if power supply to ECUs 1-3 is not interrupted, ECUs 1-3 will refrain from unnecessary communication.

(1b) When ECUs 1-3 acquire the control information output by the communication unit 54, if the control information for themselves indicates switching to the OFF state, they not only stop the transmission process but also stop communication anomaly detection by the anomaly detection unit 14. With such a configuration, communication anomaly detection, which in principle should not be executed when the power supply paths 21-23 are interrupted, can be stopped in the same manner as the transmission process. Therefore, ECUs 1-3 will not perform unnecessary processing, just as with the transmission process. Moreover, if communication anomaly detection is executed at a timing when it should not be, it may lead to erroneous determination. However, since ECUs 1-3 do not perform unnecessary communication anomaly detection, false determination can be suppressed.

(1c) When ECUs 1-3 acquire the control information output by the communication unit 54, if the control information for themselves indicates switching to the ON state, they start the transmission process and also start communication anomaly detection by the anomaly detection unit 14. With such a configuration, even if the transmission process and communication anomaly detection have been stopped due to a stuck-ON fault in the power supply switching units 31-33, the transmission process and communication anomaly detection can be resumed. Therefore, at the timing when the transmission process and communication anomaly detection should be executed, ECUs 1-3 can appropriately execute the transmission process and communication anomaly detection.

(1d) ECUs 1-5 have a wake-up state and a sleep state. ECUs 1-5 are configured to transition to the sleep state when none of ECUs 1-5 receives a communication request. If a stuck-ON fault occurs in the power supply switching units 31-33 and ECUs 1-3 cannot stop the transmission process, communication requests will be transmitted, preventing other ECUs constituting the communication system 100 from transitioning to the sleep state. As a result, the power consumption of the communication system 100 is not reduced, and battery drain may occur. However, according to the configuration described above, even if a stuck-ON fault occurs in the power supply switching units 31-33, ECUs 1-3 can stop the transmission process. Therefore, ECUs 1-3 will also stop transmitting communication requests. If all ECUs 1-5 constituting the communication system 100 can stop the transmission process, none of ECUs 1-5 will transmit communication requests, so ECUs 1-5 can transition to the sleep state. Accordingly, the power consumption of the communication system 100 can be reduced.

### 1-4. Correspondence

In the above embodiment, ECUs 1-3 correspond to a plurality of communication devices. ECU 5 corresponds to the in-vehicle device.

### 2. Other Embodiments

The embodiments of the present disclosure have been described above, but it goes without saying that the present disclosure is not limited to the above embodiments and may take various forms.

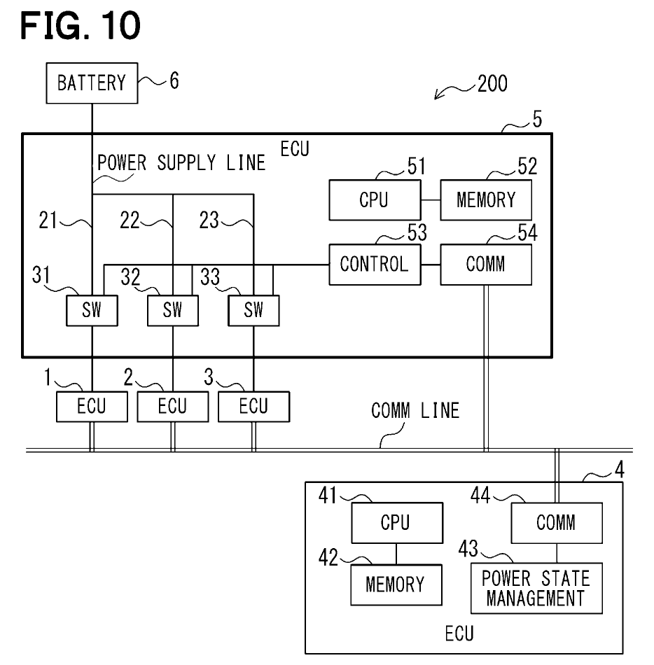

(2a) In the above embodiment, a configuration is exemplified in which the power supply switching units 31-33 are provided outside ECU 5. However, for example, as shown in the modified example 1 communication system 200 of FIG. 10, the power supply switching units 31-33 may be provided inside ECU 5.

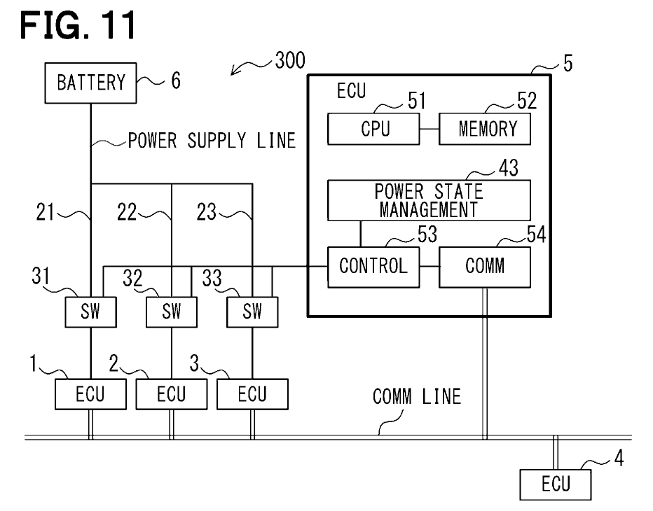

(2b) In the above embodiment, a configuration is exemplified in which ECU 4 is provided with the power state management unit 43. However, for example, as shown in the modified example 2 communication system 300 of FIG. 11, the power state management unit 43 may be provided in ECU 5. In other words, the power state management unit 43 and the control unit 53 may be provided in the same ECU. If the power state management unit 43 and the control unit 53 are provided in different ECUs and communication between these ECUs becomes impossible, the control unit 53 will not be able to acquire management information from the power state management unit 43. However, according to the modified example 2 communication system 300, since the power state management unit 43 and the control unit 53 are provided in the same ECU, the control unit 53 can acquire management information from the power state management unit 43 without communication.

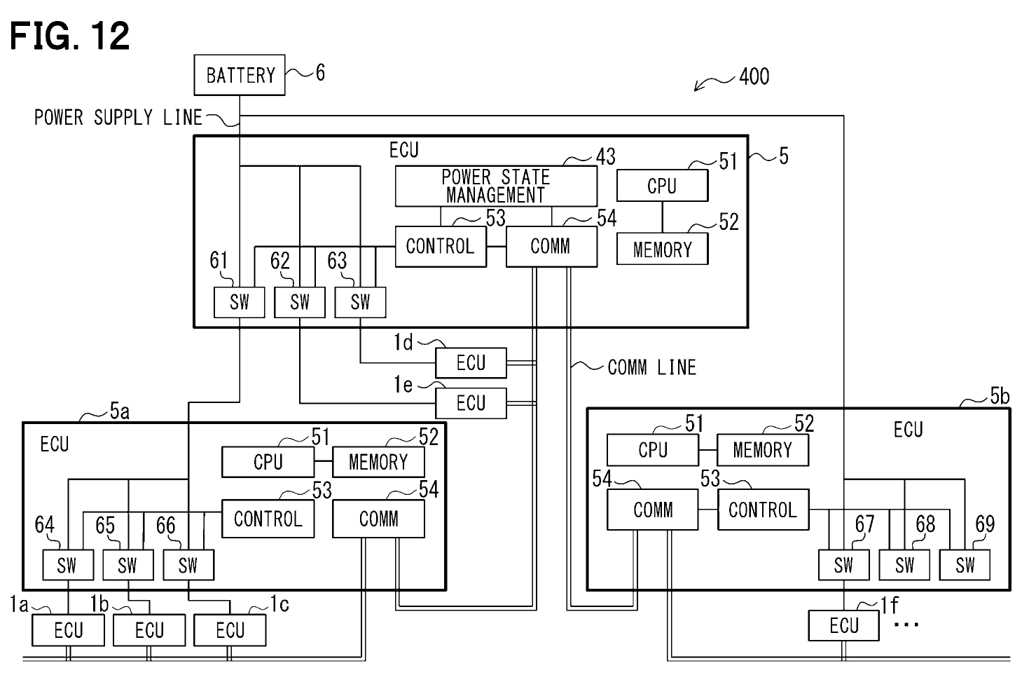

(2c) Further, for example, as shown in the modified example 3 communication system 400 of FIG. 12, ECU 5 may be provided with both the power supply switching units and the power state management unit 43. Also, the communication system may be equipped with a plurality of ECUs having a control unit 53.

In the communication system 400, the power supply switching units controlled differ for each control unit 53. As one example, the control unit 53 of ECU 5 controls the power supply switching units 61-63, the control unit 53 of ECU 5a controls the power supply switching units 64-66, and the control unit 53 of ECU 5b controls the power supply switching units 67-69. Whether the power supply switching units 61-69 should transition to the ON state or the OFF state is centrally managed by the power state management unit 43 of ECU 5.

The power supply switching unit 61 is configured to switch between the ON state and the OFF state in each power supply path between the battery 6 and each of the power supply switching units 64 to 66. The power supply switching unit 62 is configured to switch between the ON state and the OFF state in the power supply path between the battery 6 and ECU 1e. The power supply switching unit 63 is configured to switch between the ON state and the OFF state in the power supply path between the battery 6 and ECU 1d.

The power supply switching unit 64 is configured to switch between the ON state and the OFF state in the power supply path between the battery 6 and ECU 1a. The power supply switching unit 65 is configured to switch between the ON state and the OFF state in the power supply path between the battery 6 and ECU 1b. The power supply switching unit 66 is configured to switch between the ON state and the OFF state in the power supply path between the battery 6 and ECU 1c.

The power supply switching unit 67 is configured to switch between the ON state and the OFF state in the power supply path between the battery 6 and ECU 1f. Note that the ECUs corresponding to the power supply switching units 68 and 69 are omitted from the illustration.

(2d) Each device described in the present disclosure (i.e., ECUs 1-5) and the methods performed by each device may be implemented by a dedicated computer comprising a processor and memory programmed to execute one or more functions embodied in a computer program. Alternatively, each device and method described in the present disclosure may be implemented by a dedicated computer provided by configuring the processor with one or more dedicated hardware logic circuits. Or, each device and method described in the present disclosure may be implemented by one or more dedicated computers comprising a combination of a processor and memory programmed to execute one or more functions and a processor configured with one or more hardware logic circuits. Furthermore, the computer program may be stored as instructions executable by a computer on a computer-readable non-transitory tangible recording medium. The method for realizing the functions of each unit included in each device does not necessarily have to include software, and all functions may be realized using one or more hardware components.

(2e) The function of one component in the above embodiment may be distributed among a plurality of components, or the functions of a plurality of components may be integrated into one component. Further, part of the configuration of the above embodiment may be omitted. In addition, at least part of the configuration of the above embodiment may be added to, substituted for, or otherwise modified in relation to the configuration of another embodiment described above.

(2f) The present disclosure may be realized in various forms, such as a system comprising the aforementioned in-vehicle device, a program for causing a computer to function as the in-vehicle device, a medium recording the program, or a method for switching processing, in addition to the aforementioned in-vehicle device.

What is claimed is:

1. An in-vehicle device used in an in-vehicle system in which a plurality of communication devices are installed, wherein each of the plurality of communication devices is configured to receive power supply via each power supply path, and each of the power supply paths is provided with a power supply switching unit configured to switch between an ON state in which the respective power supply path is conducted and an OFF state in which the respective power supply path is interrupted, the in-vehicle device comprising
at least one of (i) a circuit and (ii) a processor with a memory storing computer program code executable by the processor, the at least one of the circuit and the processor configured to cause the in-vehicle device to
execute switching control to switch the power supply switching unit to either the ON state or the OFF state; and
communicate with the plurality of communication devices,
wherein
the at least one of the circuit and the processor outputs control information indicating whether the switching control executed is a switching to the ON state or a switching to the OFF state, when the switching control is executed; and
each of the plurality of communication devices is configured to, when the control information output corresponding to a respective communication device is acquired, stop transmission process for transmitting a communication frame when the control information indicates a switch to the OFF state for the respective communication device.

2. The in-vehicle device according to claim 1, wherein
the at least one of the circuit and the processor is further configured to manage, according to a running state of a vehicle, whether the power supply switching unit should transition to the ON state or the OFF state, and to notify management information indicating whether the power supply switching unit should transition to the ON state or the OFF state, and
the at least one of the circuit and the processor executes the switching control in accordance with the management information.

3. The in-vehicle device according to claim 1, wherein
the plurality of communication devices include an anomaly detection unit configured to execute communication anomaly detection to detect whether there is an abnormality in a communication state of the in-vehicle system, and
when the control information is acquired, if the control information for a device indicates switching to the OFF state, the communication device stops the transmission process and also causes the anomaly detection unit to stop communication anomaly detection.

4. The in-vehicle device according to claim 1, wherein
the plurality of communication devices include an anomaly detection unit configured to execute communication anomaly detection to detect whether there is an abnormality in a communication state of the in-vehicle system, and
when the control information is acquired, if the control information for that device indicates switching to the ON state, the plurality of communication devices start the transmission process and also cause the anomaly detection unit to start communication anomaly detection.

5. The in-vehicle device according to claim 1, wherein
the plurality of communication devices and the in-vehicle device have a wake-up state as a normal operating state, and a sleep state as a low power consumption operating state in which at least part of functions is restricted, and
the plurality of communication devices and the in-vehicle device are configured to transition to the sleep state when no communication request is received from any of the plurality of communication devices or the in-vehicle device.

6. An in-vehicle system comprising:
a plurality of communication devices; and
an in-vehicle device,
wherein
the plurality of communication devices and the in-vehicle device are installed in the in-vehicle system,
each of the plurality of communication devices is configured to receive power supply via a each power supply path,
each of the power supply paths is provided with a power supply switching unit configured to switch between an ON state in which the respective power supply path is conducted and an OFF state in which the respective power supply path is interrupted,
the in-vehicle device includes:
a control unit configured to execute switching control to switch the power supply switching unit to either the ON state or the OFF state; and
a communication unit configured to communicate with the plurality of communication devices,
the communication unit outputs control information indicating whether the switching control executed by the control unit is a switching to the ON state or a switching to the OFF state, when the control unit executes the switching control, and
each of the plurality of communication devices is configured to, when the control information output by the communication unit corresponding to a respective communication device is acquired, stop transmission processing for transmitting a communication frame when the control information for the respective communication device indicates switching to the OFF state.
